(19) United States
(12) Patent Application Publication
(10) Pub. No.: US 2013/0257005 A1
(43) Pub. Date: Oct. 3, 2013

(54) COMPACT WHEEL END WITH COUPLER

(71) Applicant: THE TIMKEN COMPANY, Canton, OH (US)

(72) Inventor: Jeffrey W. Schumacher, North Canton, OH (US)

(73) Assignee: THE TIMKEN COMPANY, Canton, OH (US)

(21) Appl. No.: 13/791,024

(22) Filed: Mar. 8, 2013

Related U.S. Application Data
(60) Provisional application No. 61/616,173, filed on Mar. 27, 2012.

(51) Int. Cl. B60B 27/00

(52) U.S. Cl. CPC B60B 27/001
USPC 280/124.125

(57) ABSTRACT

A compact wheel end for an automotive vehicle includes a housing, a hub having a drive flange and a spindle projecting from the flange into the housing, and an antifriction bearing located between the housing and the hub spindle. The spindle at its inboard end has an abutment, and the bearing has an inner race that is spaced from the abutment. Captured between the abutment and inner race is a splined coupler ring. It abuts the inner race at a back face on the inner race and has a beveled end that extends into an annular recess in the inner race. The drive flange of the hub has a shallow recess that receives the outboard end of the housing. The annular recess in the inner race and the shallow recess in the drive flange render the wheel end highly compact.

### CROSS REFERENCE TO RELATED APPLICATIONS

The present application is related to and claims priority from U.S. provisional patent application 61/616,173 filed Mar. 27, 2012 which is herein incorporated by reference.

### STATEMENT REGARDING FEDERALLY SPONSORED RESEARCH OR DEVELOPMENT

N/A

### BACKGROUND OF THE INVENTION

This invention relates in general to wheel ends for automotive vehicles and, more particularly, to a highly compact wheel end that may include a coupler to enable it to be engaged with an axle shaft through which torque is delivered to the wheel end and the wheel on it.

The typical wheel end for an automotive vehicle (FIG. 1) serves to couple a road wheel for the vehicle to a suspension upright, such as a steering knuckle. As such, it includes a housing 100 that is attached to the suspension upright 102, a hub 104 having a spindle 106 that extends into the housing and also a drive flange 108 to which the road wheel is attached, and an antifriction bearing 110 located between the housing and the hub spindle to enable the hub and wheel to rotate with minimal friction. Some wheel ends have splined couplers 112 that enable torque to be transferred selectively to the hub from an axle shaft, but the typical coupler fits around the spindle behind the bearing and significantly extends the length of the wheel end. This makes the wheel end difficult to package, that is to say, it makes the wheel end larger than automotive manufacturers find desirable. Or, the presence of the coupler requires shortening the bearing and thereby reducing its capacity to resist overturning moments such that those encountered when negotiating a turn.

### BRIEF DESCRIPTION OF THE DRAWINGS

FIG. 1 is a longitudinal sectional view of a conventional wheel end fitted with an axle end;

FIG. 2 is a longitudinal sectional view of the wheel end constructed in accordance with and embodying the present invention;

FIG. 3 is a fragmentary sectional view showing a coupler and inboard bearing race forming part of the present invention; and

FIG. 4 is a fragmentary sectional view showing a recess in the drive flange.

Corresponding reference characters indicate corresponding parts throughout the several views of the drawings.

### BEST MODES FOR CARRYING OUT THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to FIG. 2, a wheel end A couples a road wheel to a suspension system component, such as a steering knuckle or other suspension upright, of an automotive vehicle and is further equipped for selective engagement with an axle end D through which torque is delivered to the wheel end A and to the road wheel mounted on it. The wheel end A basically includes a housing 2 that is bolted to the suspension system component, a hub 4 to which the road wheel is attached, and an antifriction bearing 6 located between the housing 2 and the hub 4 to enable the latter to rotate with respect to the former about an axis X. The wheel end A also has a coupler ring 8 at which the hub 4 is selectively engaged with the axle end D.

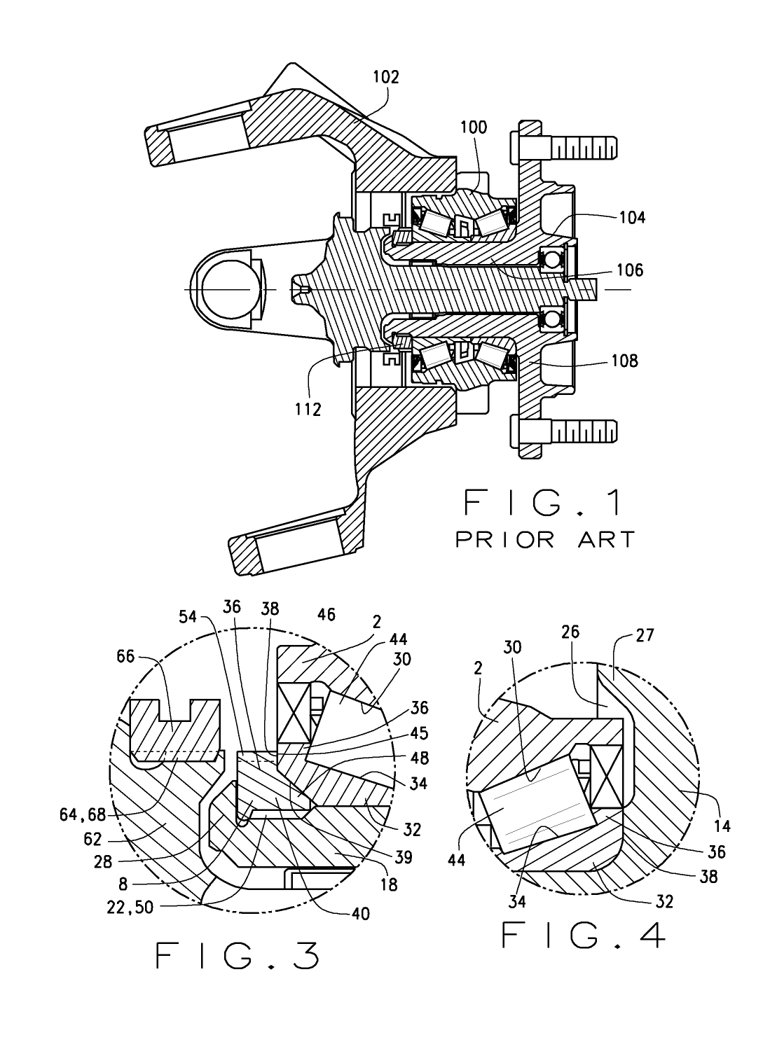

The housing 2 has a generally cylindrical body 10 and a flange 12 that projects outwardly from the body 10 intermediate the ends of the body 10. The inboard portion of the body 10 fits into the suspension system component, while the flange 12 fits against the component and receives bolts that secure the housing 2 to the component. If the suspension system component were a steering knuckle, the mounting would resemble that depicted in FIG. 1.

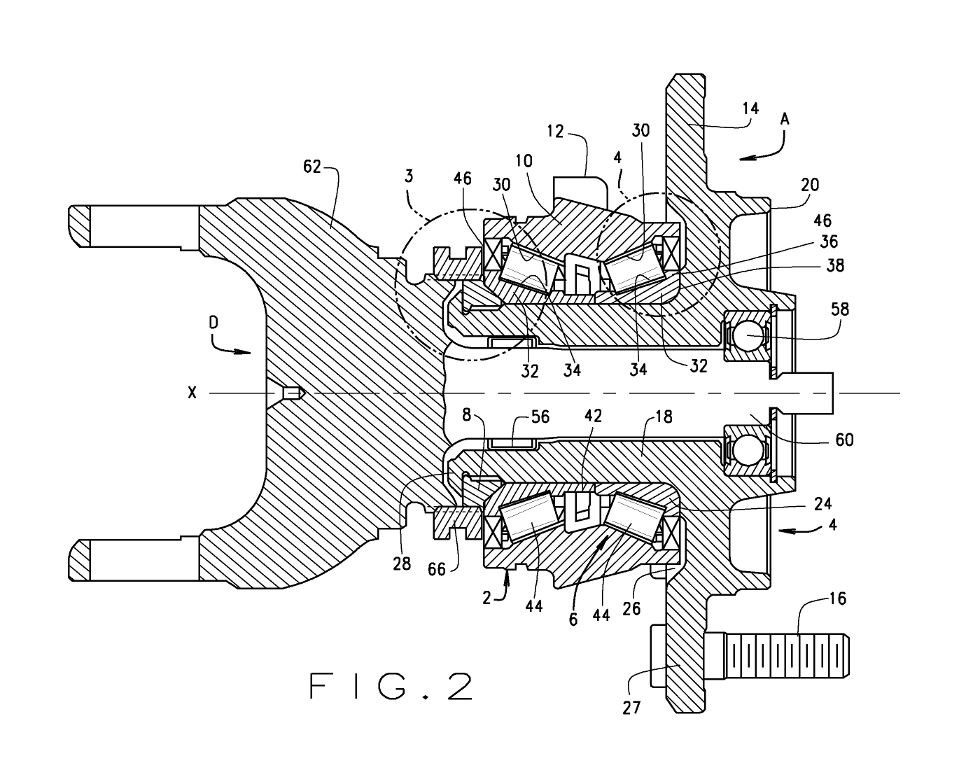

The hub 4 has a drive flange 14 that projects outwardly past the outboard end of the housing 2 and serves as a mount for the road wheel and for a brake disk or drum as well. These are secured to the flange 14 with lug bolts 16 that project from the flange 14, although they may thread into the flange 14. In addition, the hub 4 (FIG. 2) has a spindle 18 that projects axially into the housing 2 and a wheel pilot 20 that projects axially in the opposite direction. Both the spindle 18 and pilot 20 are hollow. The pilot 20 serves to center the road wheel on the hub 4. The spindle 18 at its end remote from the flange 14 has an external spline 22 (FIG. 3). The hub 2 where its flange 14 and spindle 18 merge has a shoulder 24 that lies perpendicular to the axis X, and immediately beyond the shoulder 24 the flange 14 is relieved slightly to create a shallow recess 26 (FIG. 4). Beyond the recess 26 the flange 14 is offset axially toward the housing 2, providing an offset region 27 that encircles the outboard end of the housing 2. As such, the shallow recess 26 receives the outboard end of the housing 2 while the lug bolts 16 extend through or otherwise engage the flange 14 in the offset region 27. The spindle 18 at its opposite end beyond the spline 22 is deformed outwardly in the provision of a formed end 28 that lies behind the coupler ring 8 and forms an abutment that captures both the bearing 6 and coupler ring 8 on the hub 4. U.S. Pat. Nos. 6,443,622 and 6,532,666 describe processes for upsetting the end of the spindle 18 to provide the formed end 28 and are incorporated herein by reference.

The bearing 6 enables the hub 4 to rotate relative to the housing 2 about the axis X. It includes outer raceways 30 that are presented inwardly toward the axis X and taper downwardly toward each other. They may be internal surfaces on the housing 2 itself. The bearing 6 also includes two inner races in the form of outboard and inboard cones 32. Each cone 32 has a tapered raceway 34 that leads up to a thrust rib 36 at its large end, and the thrust rib 36 in turn leads out to a back face 38 that lies perpendicular to the axis X. The back face 38 of the outboard cone 32 abuts the shoulder 24 on the flange 14 of the hub 4. The back face 38 of the inboard cone 32 abuts the coupler ring 8 and along its inner margin merges (see FIG. 3) into an oblique end surface 39 that creates an annular recess 40 within the thrust rib 36 of the inboard cone 32. The tapered raceway 34 of the outboard cone 32 is presented outwardly toward the outboard outer raceway 30 and is inclined in the same direction. The tapered raceway 34 of the inboard cone 32 is presented outwardly toward the inboard outer raceway 30 and is inclined in the same direction. Moreover, the inboard cone 32 at its opposite end has an axially directed extension 42 that leads out to and abuts the corresponding end of the outboard cone 32.

In addition to its outer raceways 30 and cones 32, the bearing 6 has rolling elements in the form of tapered rollers 44 arranged in outboard and inboard rows. The rollers 44 of the outboard row lie between and contact the outboard raceways 30 and 32, whereas the rollers 44 of the inboard row lie between and contact the inboard raceways 30 and 32. The geometry is such that the rollers 44 are on apex, meaning that the conical envelopes in which their side faces lie have their apices at common points along the axis X. Thus, the bearing 6 transfers radial loads between the housing 2 and hub spindle 18 and axial loads in both axial directions as well. The length of the axial extension 42 on the inboard cone 32 determines the setting for the bearing 6, and preferably it is one slight preload, so that no internal clearances exist in the bearing 6.

The annular spaces between the ends of the housing 2 and the cone thrust ribs 36 that lie within those ends are closed by seals 46, with the outboard seal 46 lying partially within the shallow recess 26 in the hub flange 14.

The coupler ring 8 fits tightly between the perpendicular back face 38 of the inboard cone 32 and the formed end 28. As shown in FIG. 3, it has a perpendicular end face 45 that abuts the back face 38 of the inboard cone 32 and an extended beveled end 48 that fits within the annular recess 40 of the inboard cone 32 and generally conforms to the recess 40, but with a slight clearance between the beveled end 48 and the oblique surface 39. Thus, thrust loading transfers at the abutting end face 45 and back face 38. In addition, the coupler ring 8 has an internal spline 50 that fits around and engages the external spline 22 at the inboard end of the hub spindle 18. One of the splines 22 or 50 may be provided with a slight helix to create an interference between the splines 22 and 50. This interference avoids lost circumferential motion between the coupler ring 8 and hub 4. Finally, the coupler ring 8 has an external spline 54 that extends axially away from the inboard cone 36, and is somewhat shorter than the internal spline 50.

The hub 4 carries a needle bearing 56 near its inboard end and at its outboard end carries a deep groove ball bearing 58. The two bearings 56 and 58 align along the axis X.

The axle end D (FIG. 1) projects into the hub spindle 18, and may be selectively engaged with the coupler ring 8 to transfer torque to the hub 4. In this regard, the axle end D is coupled to a differential, which in turn is coupled to a transfer case located along the drive train of the vehicle. When the transfer case is engaged with the drive train, torque is delivered to the axle end D. But the axle end D is not always engaged with the hub 4, so that the hub 4 may rotate independently of the axle end D.

The axle end D includes (see FIG. 2) a stub shaft 60 which projects into the hub spindle 18 where it is supported in the bearings 56 and 58. The axle end D also has an enlarged clutch body 62 from which the stub shaft 60 projects. The clutch body 62 has an external spline 64 that corresponds in size and spline configuration to the external spline 54 on the coupler ring 8. Axially inwardly from the clutch body 62 the axle end D is coupled to an axle shaft through a universal joint. The clutch body 62 carries a clutch ring 66 having an internal spline 68 that engages the external spline 64 of the clutch body 62. Normally the clutch ring 66 remains retracted entirely around the spline 64 of the clutch body 62 (FIG. 3). When the clutch ring 66 is so disposed, the hub 4 may rotate relative to the axle end D. The bearings 56 and 58 accommodate this rotation. However, when the clutch ring 66 is displaced axially toward the hub 4, it will at its internal spline 68 also engage the external spline 54 on the coupler ring 8, in effect bridging the clutch body 62 and the coupler ring 8 (FIG. 2). With the clutch ring 66 so disposed, torque will transfer from the axle end D to the hub 4 of the wheel end A and of course power the road wheel. The position of the clutch ring 66 is controlled by a conventional mechanism that is connected to it.

Notwithstanding its capacity to transfer torque from an axle shaft to a road wheel, the wheel end A remains highly compact. The projection of the outboard end of the housing 2 into the shallow recess 26 of the hub flange 14 and the disposition of the offset region 27 of the hub flange 14 around the outboard end of the housing 2 contribute to the compactness. So does the annular recess 40 created by the oblique surface 39 of the inboard cone 32. Indeed, the annular recess 40 and the extended beveled end 48 on the coupler ring 8 enable the engaged splines 22 and 50 to assume greater length than the external spline 54, and well they should inasmuch as they transfer torque at a lesser diameter. The coupler ring 8 and the inboard cone 32 that receives it enable the wheel end A to transfer as much, if not more, torque as a conventional wheel end of the same size, while providing a greater spread between the two rows of rollers 44 in its bearing 6. The greater spread enables the bearing 6 to better resist overturning moments.

The outboard inner cone 32 of the bearing 6 may be formed integral with the spindle 18, so that the outboard inner raceway 34 and the thrust rib 36 at the large end of that raceway 34 are surfaces of the spindle 18. Also the outer raceways 30 may be formed on separate outer races, called cups, that fit into the housing 2, or they both may be located on a single so-called double cup. Moreover, some other type of abutment, such as a nut or collar fitted to the end of the hub spindle 18, may be substituted for the formed end 28. Also, the coupler ring 8 at its beveled end 48 may abut the oblique surface 39 on the inboard cone 32, but preferably the abutment only occurs at the perpendicular end face 45 and the cone back face 38.

The bearing 6 need not be a tapered roller bearing, but instead may be an angular contact ball bearing. Thus, the rolling elements 34, instead of being tapered rollers, would be balls. Actually, the bearing 6 may be any type of antifriction bearing having inclined raceways that enable it to transfer both radial loads and axial loads.

Other types of antifriction bearings or even plain sleeve bearings could be substituted for the ball bearing 58 and needle bearing 56 that receive the stub shaft 60 at the end of the axle end B. In some wheel ends A, a single bearing, preferably at the location of the needle bearing 42 will suffice for supporting the axle end D in the hub 4.

With regard to the clutch ring 66, it may be fixed axially in position bridging the two external splines 58, 64 that its internal spline 68 engages so that the axle end D and hub 4 are permanently coupled.

Wheel ends that are not equipped with a coupler ring 8 may have on their hub drive flanges 14 provided with recesses 26 to achieve a measure of compactness.

In view of the above, it will be seen that the several objects and advantages of the present disclosure have been achieved and other advantageous results have been obtained.

1. A wheel end comprising:
a housing configured for securement to a suspension system component;
a hub having a drive flange for mounting a road wheel and a spindle extending axially from the flange into the housing, the spindle having an abutment spaced from the flange;
an antifriction bearing located between the housing and the hub spindle to enable the hub to rotate relative to the housing about an axis, the bearing including an inner race that is located around the spindle between the flange and the abutment, the inner race having an annular recess that opens toward the abutment on the spindle; and
a coupler ring captured between the abutment of the spindle and the inner race, the coupler ring having an extended end that lies within the annular recess of the inner race, the coupler ring being positioned such that thrust loading will transfer between the coupler ring and the inner race, the coupler ring being engaged with the hub spindle so that torque applied to the coupler ring will transfer to the hub.

2. A wheel end according to claim 1 wherein the inner race has a back face that is presented toward the abutment and also has an end surface along the annular recess; and wherein thrust loading is transferred between the inner race and the coupler ring at the back face of the inner race.

3. A wheel end according to claim 1 wherein the inner race has an oblique surface along the annular recess and the extended end of the coupler ring lies along the oblique surface.

4. A wheel end according to claim 3 wherein the extended end of the coupler ring is beveled with respect to the axis to generally conform to the end surface.

5. A wheel end according to claim 1 wherein the back face of the inner race and the end face of the coupler ring abut and are substantially perpendicular to the axis.

6. A wheel end according to claim 4 wherein the hub spindle and the coupler ring have engaged splines.

7. A wheel end according to claim 1 wherein the hub flange has a shallow recess that receives one end of the housing.

8. A wheel end according to claim 1 wherein the hub flange radially beyond the one end of the housing has an axially offset region that extends around that end of the housing, and further comprising lug bolts in the axially offset region.

9. A wheel end for enabling a wheel to rotate about an axis, said wheel end comprising:
a housing configured for securement to a suspension system component and having an outboard end and an inboard end;
a hub having a drive flange located at the outboard end of the housing for mounting a road wheel and also having a spindle extending axially from the flange into the housing, the spindle having an abutment spaced from the flange, the flange having an annular recess that receives the outboard end of the housing and radially beyond the recess having an axially offset region that encircles the outboard end of the housing;
an antifriction bearing located between the housing and the hub spindle and between the flange and the abutment to enable the hub to rotate relative to the housing about the axis; and
lug bolts projecting axially from the offset region of the drive flange.

10. A wheel end according to claim 9 wherein the lug bolts are anchored in the offset region of the drive flange.

11. A wheel end according to claim 9 wherein the bearing includes an inner race located around the spindle and rolling elements located between the inner race and the housing, the inner race having a back face presented toward the abutment on the spindle and an annular recess that opens toward the abutment; and wherein the wheel end further comprises a coupler ring located around the spindle between the back face of the inner race and the abutment and having an extended end that projects into the annular recess in the inner race, the coupler ring being engaged with the spindle so that torque applied to the coupler ring will transfer to the hub.

12. A wheel end according to claim 11 wherein the coupler ring has an external spline.

13. A wheel end for enabling a road wheel to rotate on a suspension system component, said wheel end comprising:
a housing configured for securement to the suspension system component and having an outboard end and an inboard end;
a hub having a drive flange located at the outboard end of the housing and a spindle that projects from the drive flange into the housing;
an antifriction bearing located between the housing and the hub spindle for enabling the hub to rotate about the axis; and
a coupler ring located around the hub spindle at the inboard end of the spindle;
and wherein the hub spindle has an abutment at the inboard end of the housing;
the bearing having an inner race located around the hub spindle;
the inner race having a back face presented toward the abutment on the spindle and also an annular recess that opens out of the inner race toward the abutment;
the coupler ring being captured between the inner race and the abutment is engaged with the spindle so that torque applied to the coupler ring will transfer to the spindle;
the coupler ring further abutting the back face of the inner race and projecting into the annular recess of the inner race;
the drive flange having a recess that receives the outboard end of the housing and radially beyond the recess has an offset region that surrounds the outboard end of the housing; and,
the offset region carrying lug bolts for securing a road wheel to the hub.

14. A wheel end according to claim 13 wherein the inner race has a surface that lies oblique to the axis and surrounds the annular recess, and the coupler ring has a beveled end that generally conforms to the annular recess.

15. A wheel end according to claim 14 wherein a slight clearance exists between the beveled end of the coupler ring and the oblique surface of the inner race.

16. A wheel end according to claim 13 wherein the coupler ring and spindle are engaged through mating splines and the coupler ring also has an external spline.
